(19) United States
(12) Patent Application Publication
(10) Pub. No.: US 2012/0274875 A1
(43) Pub. Date: Nov. 1, 2012

(54) BACKLIGHT AND LIQUID CRYSTAL DISPLAY DEVICE USING THE SAME

(75) Inventors: KOICHI SAKITA, Chigasaki (JP); Makoto Tsumura, Hitachi (JP); Hiroshi Iwasa, Hayama (JP); Susumu Ishida, Yokohama (JP)

(73) Assignee: Hitachi Consumer Electronics Co., Ltd.

(21) Appl. No.: 13/453,356

(22) Filed: Apr. 23, 2012

(30) Foreign Application Priority Data
Apr. 27, 2011 (JP) 2011-099739

(51) Int. Cl. G02F 1/13357; F21V 8/00

(52) U.S. Cl. 349/62; 362/612

(57) ABSTRACT

In a backlight using an LED, area control is performed such that the backlight is lit only in the bright area of the screen and the backlight is not lit in the dark area. The temperature change in the light emission efficiency of the LED is large. The temperature of the lit LED is high in area control, so that when a completely gray screen is displayed after the area control, the light emission efficiency of the LED decreases in the previously illuminated area, resulting in the occurrence of uneven brightness. The present invention prevents the uneven brightness of the screen in area control, by reducing the temperature change in the light emission efficiency of the LED to 5% or less, and more preferably 3% or less, in a temperature range of 50° C. to 90° C.

### CLAIM OF PRIORITY

The present application claims priority from Japanese Patent Application JP 2011-099739 filed on Apr. 27, 2011, the content of which is hereby incorporated by reference into this application.

### FIELD OF THE INVENTION

The present invention relates to a liquid crystal display device using an LED as a backlight, and more particularly to a liquid crystal display device having a backlight with less occurrence of uneven brightness even when area control is performed.

### BACKGROUND OF THE INVENTION

A liquid crystal display device includes a TFT substrate and a color filter substrate. The TFT substrate is configured such that pixel electrodes, thin film transistors (TFTs) and the like are arranged in a matrix form. The color filter substrate is disposed opposite to the TFT substrate, in which color filters and the like are formed at locations corresponding to the pixel electrodes of the TFT substrate. A liquid crystal is sandwiched between the TFT substrate and the counter substrate. In this way, the liquid crystal display device forms an image by controlling the transmittance of light of the liquid crystal molecules for each pixel.

Liquid crystal display devices can be made thin and light weight, and are used in a wide range of applications. The liquid crystal does not emit light itself, so that a backlight is provided on the back side of a liquid crystal display panel. Fluorescent tubes have been used as a backlight for liquid crystal display devices having a relatively large screen such as TV. However, the fluorescent tube is filled with mercury vapor, imposing a heavy burden on the environment of the Earth. In particular in European and other countries, the use of such a fluorescent tube tends to be prohibited.

Under these circumstances, the fluorescent tube has been replaced by an LED (light emitting diode) as a light source of the backlight. More and more liquid crystal display devices with an LED light source are used every year also in large display devices such as TVs. The backlight of the liquid crystal display device requires planar light source. However, the LED is a point light source. Thus, it is necessary to provide an optical system to form a planar light source by point light source LEDs.

There are two types of LED, one is top-view LED and the other is side-view LED. JP-A No. 130008/2010 describes a configuration for reducing the stress caused by the difference in the thermal expansion coefficient of each material in a side-view LED package. JP-A No. 130008/2010 also describes a configuration of the side-view LED in which an LED chip is directly mounted on a conductive lead, without using a lead frame.

JP-A No. 288396/2008 describes an example of an LED with nearly flat temperature characteristics of the relative brightness.

Further, JP-A No. 293339/2007 describes a backlight in which blocks each having an LED and a light guide plate (light guide member) are arranged in a matrix to control the LED of each block separately.

### SUMMARY OF THE INVENTION

In JP-A No. 293339/2007, the backlight is formed by arranging a plurality of blocks, which are a combination of an LED and a light guide member. In this configuration, when the change in the light emission efficiency of the used LED is large with respect to the temperature change, for example, the special light intensity of the backlight varies even when the same voltage is applied to the LEDs of all the blocks, that is, the so-called brightness uniformity occurs.

Such uneven brightness is considered in the case of using LEDs whose light emitting efficiency is greatly reduced due to a temperature increase. In this case, for example, the LED of a certain block is lit with the maximum brightness and LEDs of other blocks are turned off. This state is maintained for a predetermined period of time. Then, the LEDs of all the blocks are lit with the maximum brightness. At this time, there is a possibility that the light from the particular certain block is darker than the light from the other blocks, that is, uneven brightness occurs. It is because the LED of the certain block is lit with the maximum brightness so that the temperature of the particular LED increases and the light emission efficiency decreases while the LEDs of the other blocks are turned off and the temperature of the LEDs does not increase so that the decrease in the light emission efficiency is smaller than in the case of the LED of the certain block.

As described above, in the backlight using a plurality of combinations of LED and a light guide member, there is a possibility that uneven brightness occurs due to the use of the LED in which the change in the light emission efficiency is large with respect to the temperature change. Thus, for the backlight with such a configuration, it is desirable to use the LED in which the change in the light emission efficiency is small with respect to the temperature change.

Further, the temperature of the LED increases in the operation. In general, the efficiency of the LED is reduced at a high temperature. There are two types of LEDs. One is top-view LED and the other is side-view LED. Although described below, the top-view LED can be configured to easily dissipate heat. However, when the top-view LED is used as the light source of a thin-direct-type backlight, and particularly when high-output LEDs are used and the number of LEDs is reduced, the uneven brightness is said to be likely to occur in the display area. On the other hand, the side-view LED uses the light guide member and can be configured to prevent the occurrence of the uneven brightness in the display area. However, heat is not easily dissipated from the LED in the configuration of the side-view LED.

Recently, a driving method called area control has been used to meet the requirements such as saving power and increasing contrast. In FIG. 24, for example, the display area is divided into eight areas in the horizontal direction and six areas in the vertical direction, namely, 48 areas in total. Each divided area is provided with a single or a plurality of LEDs. For example, when an image is formed only in an area 101 and the other remaining areas are black, only the LED corresponding to the area 101 is lit instead of lighting the backlight in the entire display area. In this case, the power consumption of the LED is reduced by one forty-eighth compared to the case of lighting the backlight in the entire display area.

However, in FIG. 24, current flows through the LED corresponding to the area 101 in which the temperature is higher than in the other LEDs. The light emission efficiency of the LED decreases when the temperature increases. In this state, it is assumed that the screen is changed and a completely gray screen is displayed as shown in FIG. 25.

In FIG. 25, the temperature of the LEDs, excepting LED corresponding to the area 101, does not increase before the gray display. However, in the portion of the area 101 shown in FIG. 25, the current flows through the corresponding LED before the gray display, so that the temperature of the LED increases. The light emission efficiency of the LED decreases when the temperature increases. For this reason, the brightness in the portion of the area 101 in FIG. 25 is lower than in the other portion. As a result, uneven brightness occurs on the screen.

Various methods have been used to solve this problem, such as a method using an LED with high light emission efficiency, and a method for preventing the temperature increase in the LED by reducing the thermal resistance from the LED to the LED mounting board. However, the uneven brightness may occur when the number of LEDs is reduced and when high-output LEDs are used.

It would be desirable to provide a configuration reduce the uneven brightness in the display area when area control is performed using LED as a light source.

(1) There is provided a backlight including an array of a plurality of light source blocks each having an LED, and a light guide member for converting light from the LED into a planar light to irradiate a liquid display panel. The backlight can control the intensity of the light for each light source block. The temperature change in the light emission efficiency of the LED in the temperature range of 50° C. to 90° C. is 5% or less.

(2) There is provided a backlight including a light guide plate and an LED, in which area control can be performed. The light guide plate has rows of recesses that are arranged at a predetermined pitch in a first direction. The rows of recesses are arranged at a predetermined interval in a second direction orthogonal to the first direction. The LED is a side-view LED and is placed in the recess. The temperature change in the light emission efficiency of the LED is 5% or less, and more preferably 3% or less, in the temperature range of 50° C. to 90° C.

(3) In the backlight described in (1), the LED includes two LED chips. The temperature coefficients of the light emission efficiency of the two LED chips are different from each other. The light emission efficiency of the LED using the two LED chips is 5% or less, and more preferably 3% or less, in the temperature range of 50° C. to 90° C. as a whole.

(4) There is provided a backlight including a light guide plate and an LED, in which area control can be performed. The light guide plate has rows of recesses that are arranged at a predetermined pitch in a first direction. The rows of the recesses are arranged at a predetermined interval in a second direction orthogonal to the first direction. The LED is a side-view LED. A plurality of LEDs are placed into the recess. The temperature coefficient of the light emission efficiency of at least one of the plurality of LEDs is different from the temperature coefficient of the light emission efficiency of the other LEDs. The temperature change in the light emission efficiency of the plurality of LEDs is 5% or less, and more preferably 3% or less, in the temperature range of 50° C. to 90° C. as a whole.

Further, there is provided a liquid crystal display capable of performing area control without uneven brightness by using the backlights described above.

According to the present invention, the emission efficiency of the used LED is small with respect to the temperature change in the temperature range of the LED light emission. Thus, it is possible to display a high quality image with less occurrence of uneven brightness.

Further, according to the present invention, the side-view LED is placed into the recess of the light guide plate, so that the thickness of the backlight can be reduced and the uneven brightness can be reduced in the backlight. Further, in the liquid crystal display device using the backlight described above, it is possible to reduce the uneven brightness in area control, by using the side-view LED in which the temperature change in the light emission efficiency is 5% or less, and more preferably 3% or less, in the temperature range of 50° C. to 90° C.

### BRIEF DESCRIPTION OF THE DRAWINGS

FIG. 1 an exploded perspective view of a liquid crystal display device;

FIG. 2 is a plan view of a light guide plate according to the present invention;

FIG. 3 is a cross-sectional view taken along line A-A of FIG. 2;

FIG. 4 is a cross-sectional view taken along line B-B of FIG. 2;

FIG. 5 is a cross-sectional view taken along line C-C of FIG. 2;

FIG. 6 is a plan view of a wiring substrate in which LEDs are arranged;

FIG. 7 is a cross-sectional view taken along line D-D of FIG. 6;

FIG. 8 is a cross-sectional view taken along line E-E of FIG. 7;

FIG. 9 is a perspective view of an assembly of the light guide plate and the wiring substrate in which LEDs are provided;

FIG. 10 is a cross-sectional view of a top-view LED that is placed into a recess of the light guide plate;

FIG. 11 is a cross-sectional view of a side-view LED that is placed into a recess of the light guide plate;

FIGS. 12A and 12B are views of the side-view LED according to a first embodiment, in which FIG. 12A is a front view and FIG. 12B is a side view;

FIG. 13 is a cross-sectional view taken along line A-A of FIG. 12A;

FIG. 14 is a schematic view showing the relationship of a lead frame, an LED chip, and wires according to the first embodiment;

FIG. 15 is a graph showing the temperature characteristics of the light emission efficiency of the LED according to the first embodiment;

FIG. 16 is a graph showing the relationship between the light beam, current, and voltage between terminals of the LED, and the temperature;

FIGS. 17A and 17B are views of the side-view LED according to a second embodiment, in which FIG. 17A is a front view and FIG. 17B is a side view;

FIG. 18 is a cross-sectional view taken along line B-B of FIG. 17A;

FIG. 19 is a graph showing the relationship between the light emission efficiency of two LEDs and the temperature according to the second embodiment;

FIG. 20 is an example of the temperature characteristics of each of the two LEDs, and the total temperature characteristics according to the second embodiment;

FIG. 21 is a graph showing the relationship between the light emission efficiency of the LED, and the temperature according to the second embodiment;

FIG. 22 is a perspective view showing the relationship of the wiring substrate, the LED chips, and the light guide plate according to a third embodiment;

FIG. 23 is a plan view showing the arrangement of the LEDs on the wiring substrate according to the third embodiment;

FIG. 24 is an example of area control performed in the display area; and

FIG. 25 is an example of a completely gray screen is displayed after the area control is performed.

### DETAILED DESCRIPTION OF THE PREFERRED EMBODIMENTS

Hereinafter, the present invention will be described in detail through embodiments.

### First Embodiment

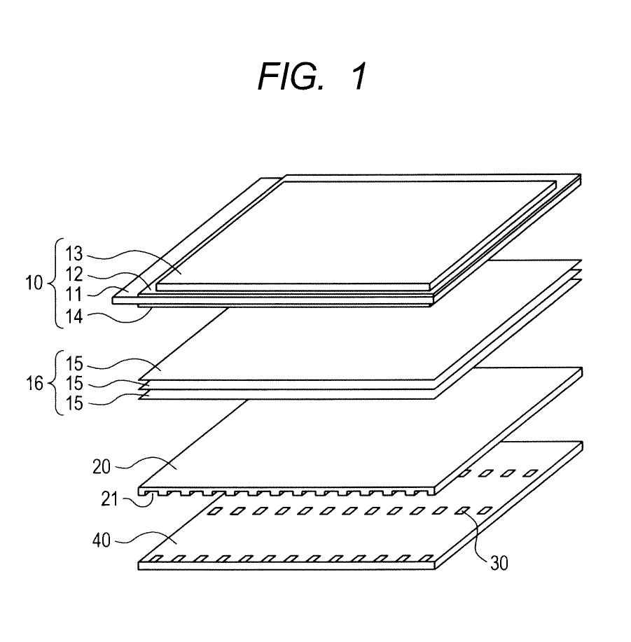

FIG. 1 is an exploded perspective view of a liquid crystal display device according to the present invention. FIG. 1 is divided into two parts. One is a liquid crystal display panel 10 and the other is a backlight. In FIG. 1, a TFT substrate 11 in which TFTs and pixel electrodes are arranged in a matrix, and a counter substrate 12 in which color filters are formed, are bonded together with an adhesive material (not shown). A liquid crystal (not shown) is sandwiched between the TFT substrate 11 and the counter substrate 12.

A lower polarization plate 14 is attached to the lower side of the TFT substrate 11, and an upper polarization plate 13 is attached to the upper side of the counter substrate 12. The state of adhesion of the TFT substrate 11, the counter substrate 12, the lower polarization plate 14, and the upper polarization plate 13 is referred to as the liquid crystal display panel 10. A backlight is provided on the back side of the liquid crystal display panel 10. The backlight includes a light source part and various optical components.

in FIG. 1, the backlight is formed by optical sheets 16, a light guide plate 20, and a wiring substrate 40 in which LEDs 30 are provided, in this order from the side of the liquid crystal display panel 10. The wiring substrate 40 is a monolithic substrate in this embodiment, but it can also have a distributed structure with a plurality of substrates. The optical sheets 16 shown in FIG. 1 include three diffusion sheets 15. The optical sheets 16 may include the so-called prism sheets, lens sheets, or reflective polarization films. The number of diffusion sheets 15 can be one or two. It is also possible to use the light diffusion sheet or light diffusion plate with anisotropic characteristics.

The optical sheets 16 are placed on the light guide plate 20. The light guide plate 20 has the role of directing light from a large number of LEDs 30 toward the liquid crystal display panel 10. The light guide plate 20 has a thin planar shape. A large number of recesses 21 are arranged in the horizontal direction on the lower surface of the light guide plate 20. The recesses 21 are arranged in three rows in the vertical direction. The LEDs 30 provided in the wiring substrate 40 are inserted into the recesses 21 of the light guide plate 20.

The wiring substrate 40 is provided below the light guide plate 20. The LEDs 30 are arranged in-line in three rows corresponding to the recesses 21 of the light guide plate 20. In the description of this embodiment, it is assumed that the LEDs 30 are white LEDs 30. However, also in the case of using monochrome LEDs 30, the present invention described below can be applied as long as the three colors are carefully mixed.

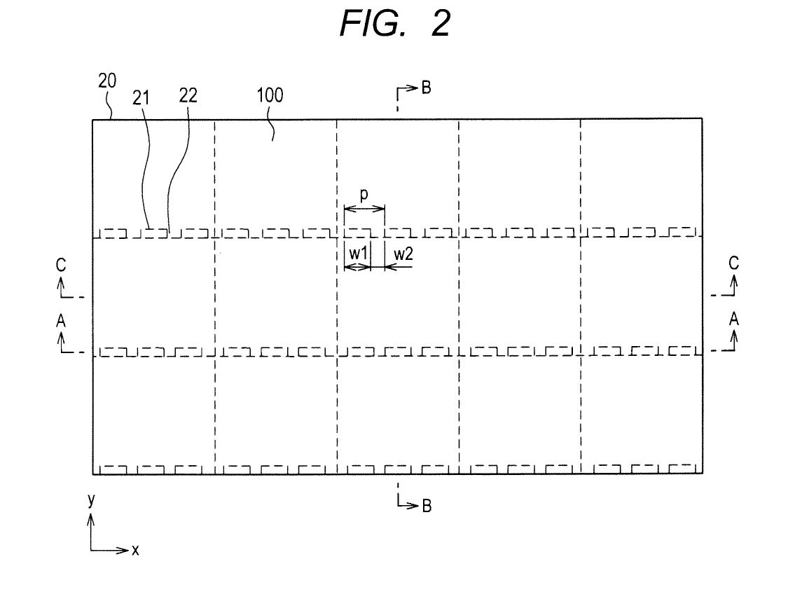

When the light guide plate 20 and the wiring substrate 40 overlap with each other, the LEDs 30 arranged in-line are placed into the recesses 21 arranged in-line on the lower surface of the light guide plate 20. With this configuration, it is possible to reduce the thickness of the liquid crystal display device. Such an arrangement of the LEDs 30 can reduce the area of the frame around the display area of the liquid crystal display device, compared to the conventional side light type backlight. In addition, this arrangement of the LEDs 30 allows for area control of the brightness of the screen. Here, the so-called area control, or local dimming, means to control the LEDs individually corresponding to the areas (surrounded by the dashed lines shown in FIG. 2 described below) of the backlight according to each area image. For example, when the image of the liquid crystal display panel 10 corresponding to a certain area is dark, the light intensity of the LED 30 corresponding to the particular area is reduced. When the image of the liquid crystal display panel 10 corresponding to another area is bright, the light intensity of the LED 30 corresponding to the particular area is increased. In this way, the area control can increase the contrast of the image and reduce power consumption of the backlight.

In other words, the area is the minimum unit for controlling the light intensity by area control. For example, when continuous or adjacent three LEDs are defined as one unit of light source to be controlled, the portion mainly irradiated with light from the three LEDs is one area. In other words, as shown in FIG. 2, there are a plurality of rows of the LEDs 30 arranged in line in the x direction. The rows of the LEDs are arranged in the y direction. Then, the adjacent three LEDs of the LED row are defined as one LED group. At this time, the portion surrounded by the boundaries of the LED groups in the x direction and by the LED rows is the area. In the following description, the combination of one or a plurality of LEDs constituting the area of the backlight, and the light guide plate may also be referred to as the “light source block”.

FIG. 2 is a plane view of the light guide plate 20 used in FIG. 1. In FIG. 2, there are three rows of the recesses 21 arranged in-line in the x direction. Then, the three rows of the recesses 21 are arranged in the y direction. The LED is placed into each of the recesses 21. Since the three adjacent LEDs 30 are controlled as one unit, the area indicated by the dashed lines in FIG. 2 is one light source block 110. Thus, the screen can be divided into the light source blocks 110. Note that there is no separation corresponding to the dashed line in the light guide plate 20. In this embodiment, the three adjacent LEDs 30 are controlled as one unit, but the present invention is not limited to this configuration. The number of LEDs of one unit can be one, or three or more, within the range in which the uneven brightness in the control area can be prevented. It is also possible to provide grooves or cut-outs in the locations corresponding to the dashed lines in FIG. 2 to (optically) separate the areas.

With this configuration, the backlight can be configured such that the light source blocks 110 are arranged in a matrix to allow light source block by the area control as described above. Note that in FIG. 2, the separated light source blocks are shown for convenience. However, this does not mean that the light guide plate 20 is physically separated. In this example, the light guide plates of the light source blocks 110 are integrated into one piece. Of course, the light guide plates of the light source blocks 110 can be physically separated from each other.

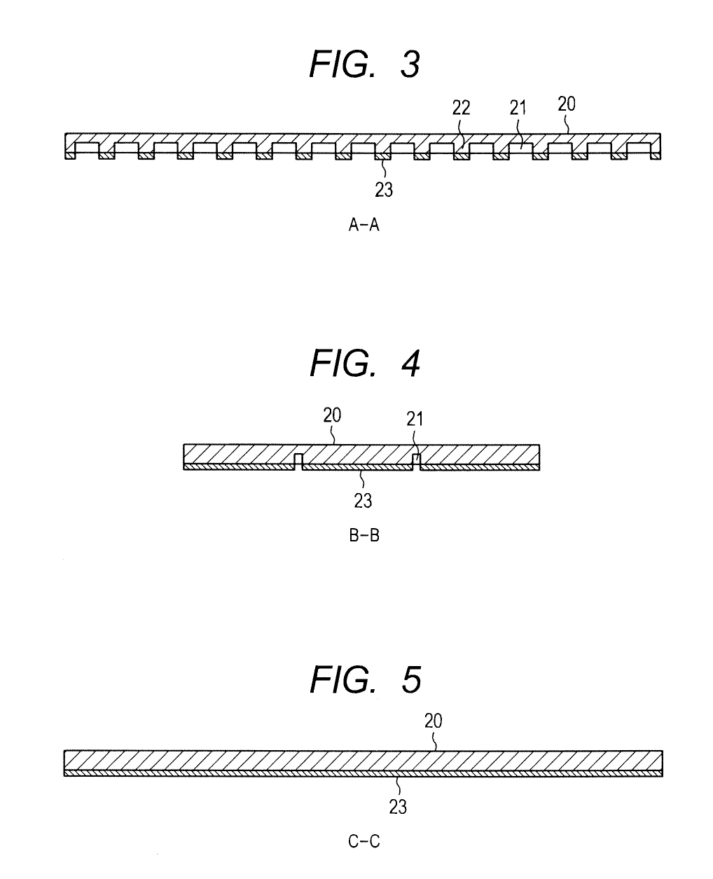

FIG. 3 is a cross-sectional view taken along line A-A of FIG. 2. In FIG. 3, the recesses 21 are arranged at a predetermined pitch in the horizontal direction of the light guide plate 20. There is provided a rib 22 between the recesses 21. The rib 22 is principally to increase the strength of the light guide plate 20. The light can leak into another area also through the rib. FIG. 4 is a cross-sectional view taken along line B-B of FIG. 2. In FIG. 4, the recesses 21 are formed in the light guide plate 20 to house the LEDs 30. FIG. 5 is a cross-sectional view taken long line C-C of FIG. 2. In FIGS. 3 to 5, a reflective sheet 23 is attached to the lower surface of the light guide plate 20. The reflective sheet 23 is to direct the light from the LED 30 toward the liquid crystal display panel 10.

Now returning to FIG. 2, the rib 22 is provided between the recesses 21 of the light guide plate 20 to increase the strength of the light guide plate 20. Another role of the rib 22 is to allow light to enter between the areas indicated by the dashed lines in the y direction. In other words, considering workability in terms of placing the LEDs 30 in the light guide plate 20, it is preferable to continuously form the recesses 21 in the x direction as a groove, instead of forming the recess 21 for each LED 30. However, when the continuous groove is formed, the strength of the light guide plate is reduced, and the interference in the y direction is not likely to occur. For this reason, the recesses 21 of the light guide plate 20 are formed individually for each LED 30, so that the rib 22 can be formed between the recesses 21.

Thus, the rib 22 should have a width of a predetermined width value. In FIG. 2, the pitch in the x direction of the recess 21 is p, the width in the x direction of the recess 21 is w1, and the width of the rib 22 is w2, where p=w1+w2. Although the width of the rib 22 depends on the number of LEDs 30 per unit of the screen 100 or on the pitch of the LED 30, is preferable that w2/p is 1/3 or more if design allows. However, as long as the strength of the light guide plate 20 can be ensured, the recesses 21 of the light guide plate 20 do not necessarily have the rib 22 and may be a continuous groove.

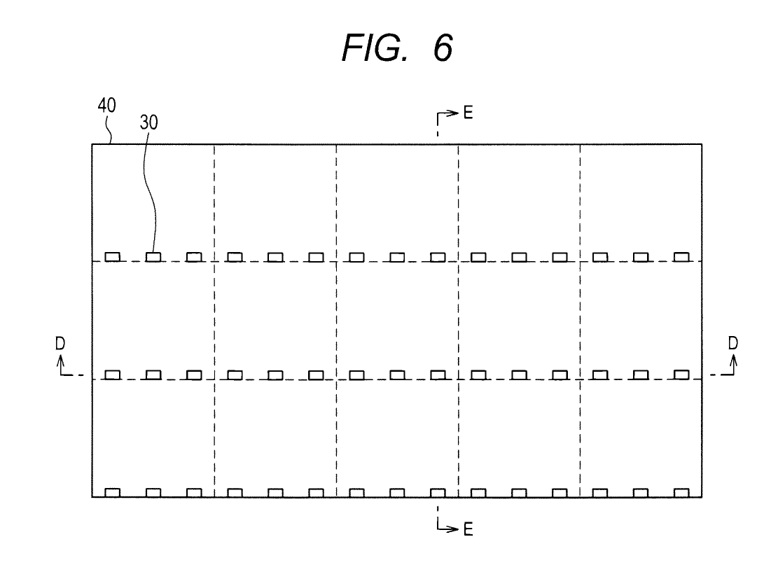

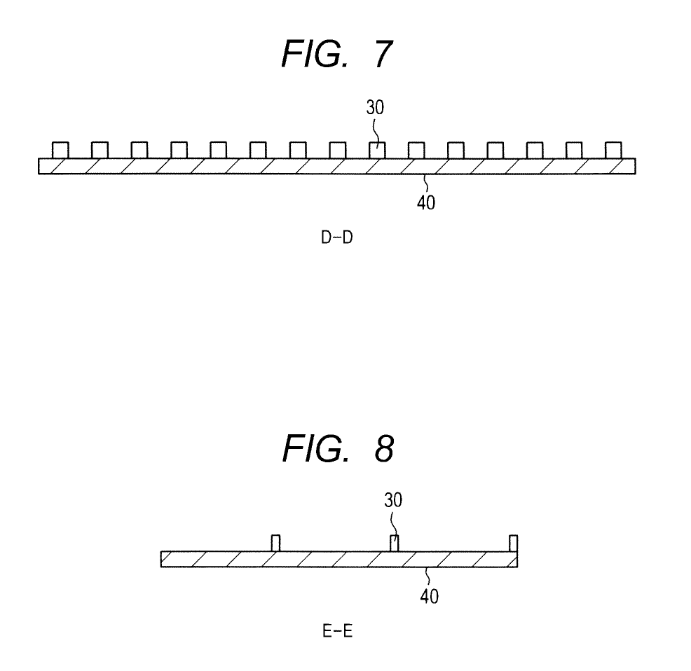

FIG. 6 is a plan view of the wiring substrate 40 on which the LEDs 30 are mounted. FIG. 7 is a cross-sectional view taken along line D-D of FIG. 6, and FIG. 8 is a cross-sectional view taken along line E-E of FIG. 6. In FIG. 6, there are three rows of the LEDs 30 arranged in line. Each LED 30 is inserted into the recess 21 of the light guide plate 20. In FIG. 6, the three adjacent LEDs 30 are controlled as one unit. In FIG. 6, the dashed lines indicate the area controlled by the three LEDs 30.

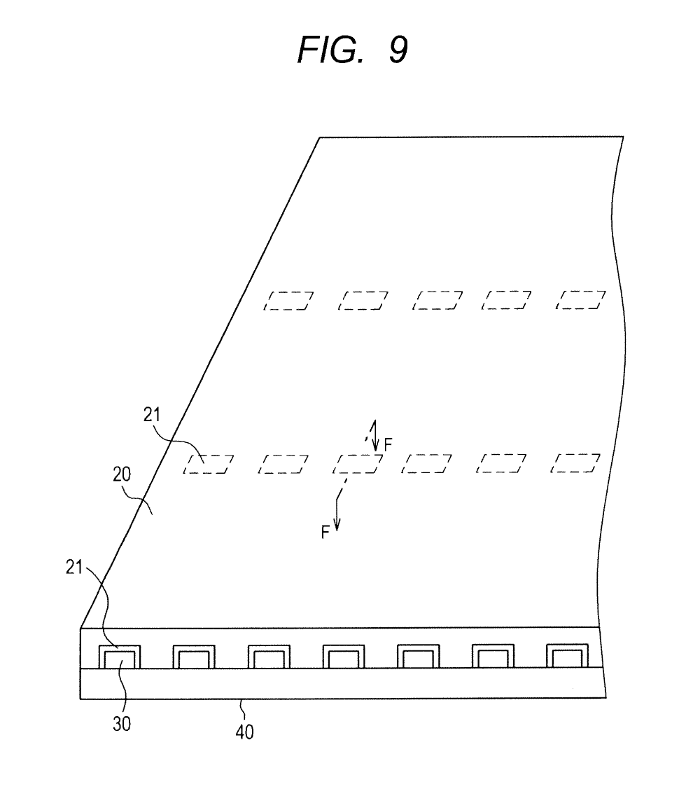

FIG. 9 is a perspective view showing the state in which the light guide plate shown in FIG. 2 and the wiring substrate 40 shown in FIG. 6 are combined together. In FIG. 9, the LEDs 30 on the wiring substrate 40 are inserted into the recesses 21 of the light guide plate 20. As shown in FIG. 9, the size of the recess 21 is larger than the LED 30, by taking into account the placement accuracy of the LEDs 30 on the wiring substrate 40, the positional accuracy of the recesses 21 of the light guide plate 20, and the assembly accuracy of the wiring substrate 40 and the light guide plate 20.

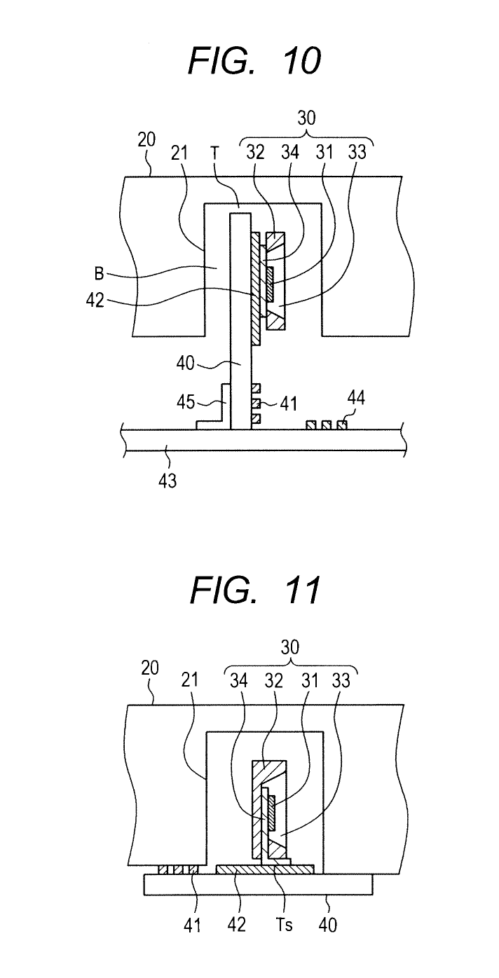

There are two types of the LED 30. One is top-view type LED and the other is side-view type LED. FIG. 10 is an example in which the top-view LED 30 is placed into the recess 21 shown in FIG. 9. FIG. 11 is an example in which the side-view LED 30 is placed into the recess 21. In FIG. 10, a portion of the wiring substrate 40 is also inserted into the recess 21. A connection terminal 42 is formed on a surface of the wiring substrate 40. The LED 30 with a lead frame 34 is placed on the connection terminal 42. An LED chip 31 is placed in a resin 32 of the LED 30. Then, a wavelength conversion material 33 (for example, a mixture of fluorescence substance and transparent resin) is filled on the LED chip 31. The structure of the top-view LED shown in FIG. 10 has an advantage that the heat can be easily dissipated due to the short distance from the LED chip 31 to the connection terminal 42 in the wiring substrate 40. However, it has the following problems.

In FIG. 10, light from the top-view LED 30 is input to the side surface of the recess 21 of the light guide plate 20. In the recess 21, hardly any light can reach the top portion T of the wiring substrate 40, so that the portion T is dark. Further, the wiring substrate 40 does not easily reflect light, so that in particular, the back portion B of the wiring substrate 40 in the recess 21 is likely to have a low brightness. As described above, the top-view LED 30 can easily dissipate heat and prevent the efficiency from decreasing due to the temperature change in the LED 30. However, there is a problem that the uneven brightness of the backlight can easily occur. Note that in FIG. 10, the wiring substrate 40 is inserted into the recess, and a wiring substrate 43 is provided in the direction orthogonal to the wiring substrate 40. The wiring substrate 40 is fixed to the wiring substrate 43 by a fixing member 45. At this time, a line 41 of the wiring substrate 40 and a line 44 of the wiring substrate 43 are electrically coupled, and then coupled to the LED chip, the light source of the backlight, and the like.

FIG. 11 is an example in which the side-view LED 30 is inserted into the recess 21. The side-view LED 30 is placed on the connection terminal 42 of the wiring substrate 40 that supplies power to the LED 30. In FIG. 11, the LED chip 31 is attached to the L-shaped lead frame 34. The entire LED chip 31 is sealed by the resin 32. The wavelength conversion material 33 is filled on the LED chip 31. In FIG. 11, the line 41 is formed on the surface on which the connection terminal 42 of the wiring substrate 40 is formed.

In FIG. 11, the wiring substrate 40 is not present within the recess 21, so that it is possible to prevent the uneven brightness described in FIG. 10. However, in the configuration of FIG. 11, it is difficult to dissipate the heat generated in the LED 30 due to a long distance from the LED chip 31 to the connection terminal 42 of the wiring substrate 40. The temperature of the LED 30 is likely to increase, resulting in a problem of decreasing the light emission efficiency of the LED 30. Note that in FIG. 11, the temperature of the portion of connecting the lead frame 34 and the connection terminal 42 is denoted by Ts, and the temperature of a PN junction of the LED chip 31 is denoted by Tj.

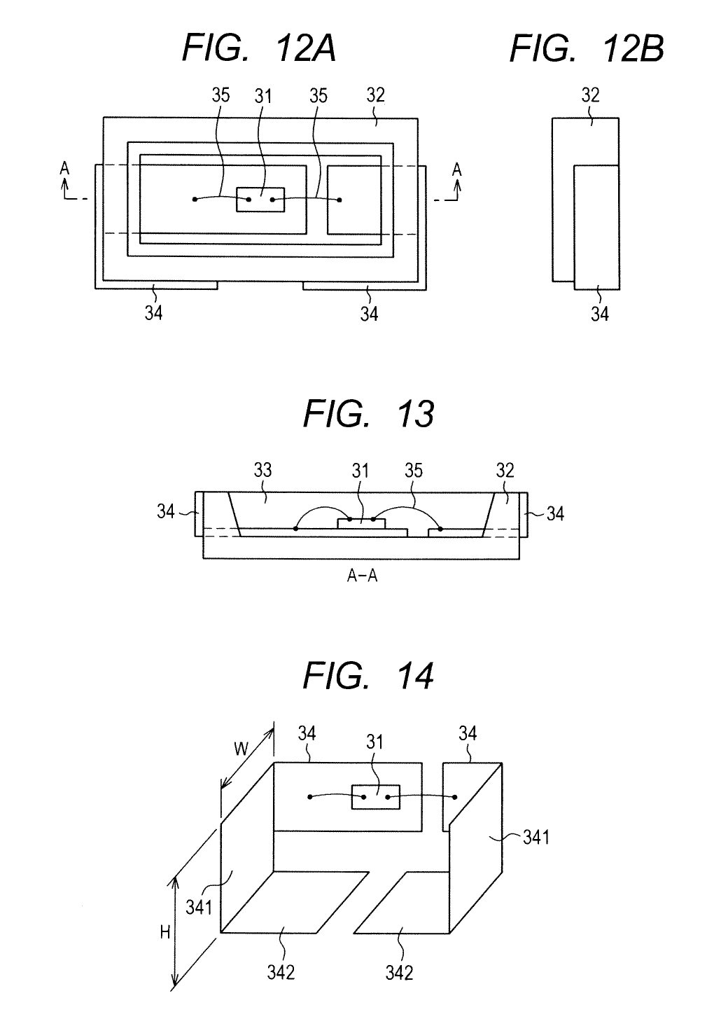

FIG. 12A is a front view of an example of the side-view LED 30. In FIG. 12A, the lead frame 34 is placed within the resin 32. The lead frame 34 extends to the outside through the inside of the resin 32. As shown in FIG. 12B, the lead frame 34 covers the side surface of the resin 32 and extends down beyond the resin 32. Then, the lead frame 34 is connected to the connection terminal 42 of the wiring substrate 40 not shown. Inside the resin 32, the LED chip 31 is placed on one of the two lead frames 34, and the terminals of the LED chip 31 are connected to the two lead frames 34 by wires 35.

FIG. 13 is a cross-sectional view taken along line A-A of FIG. 12A. In FIG. 13, the resin 32 has a bathtub-like hollow. The lead frames 34 and the LED chip 31 are provided in the hollow. The LED chip 31 and the lead frames 34 are connected by the wires 35. The bathtub-like portion of the resin 32 is filled with the wavelength conversion material 33.

FIG. 14 is a perspective view of the LED 30 described in FIGS. 12A and 12B and FIG. 13, only showing the shape of the lead frames 34, the LED chip 31, and the wires 35. The heat generated in the LED chip 31 is conducted to the wiring substrate 40, not shown, through the lead frames 34. In FIG. 14, if the height H of a side portion 341 of the lead frame 34 is larger than the width W thereof, the heat could not be easily conducted to a bottom portion 342 of the lead frame 34. However, in the side-view LED 30, the lead frame 34 is likely to have such a configuration. The present invention is particularly useful when using the side-view LED in which the heat could not be easily conducted from the LED chip to the connection terminal 42.

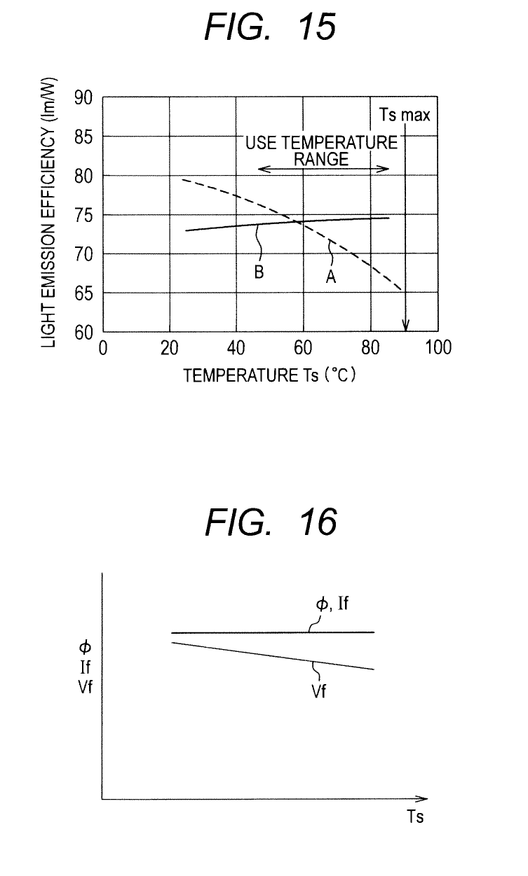

FIG. 15 is a graph showing the relationships between the light emission efficiency and the temperature in the side-view LED used in the conventional backlight and in the side-view LED in the first embodiment according to the present invention. As the indicator of the temperature of the LED 30, there are two temperatures. One is the temperature Tj of the PN junction portion of the LED 30. The other is the temperature Is of the lead frame 34 in the connection terminal 42 of the wiring substrate 40. The temperature of Tj is higher than Ts. The relationship between Tj and Ts is expressed as Tj=Rth(j−s)W+Ts. Here, Rth(j−s) is the thermal resistance of the lead frame 34 from the connection portion of the LED 30 to the connection terminal 42, and W is the input power.

In FIG. 15, the horizontal axis represents Ts. The temperature change in the light emission efficiency of the LED 30 used in the conventional technology is large. When the use temperature of the LED 30 is Ts in the temperature range of 50° C. to 90° C., the following equation is obtained based on the efficiency of 76 lumen/W at 50° C.: (76−65)/76=14.4%. On the other hand, the temperature change in the light emission efficiency of the LED 30 used in the present invention is small, in which (74.5−73.5)/73.5=1.3% is obtained based on the efficiency of 74.5 lumen/W at 50° C.

As described above, by using the LED 30 with a small temperature change in the light emission efficiency, the brightness uniformity will not be degraded due to the influence of the previous image in the area control. According to the experiment, in the area control at Ts in the temperature range of 50° C. to 90° C., the range that can prevent such uneven brightness is 5% or less, and more preferably 3% or less. This LED 30 is commercialized, such as, for example, GM2QT450G produced by Showa Denko. K.K. Further, JP-A No. 288396/2008 describes the blue LED characteristics with excellent temperature stability, but only in terms of the relative brightness.

FIG. 15 shows the case in which the temperature coefficient of the light emission efficiency of the LED 30 is positive. However, if the temperature coefficient of the light emission efficiency of the LED 30 is negative and its value is small, it is possible to prevent the uneven brightness from occurring due to the influence of the previous image in area control. In this case also, the temperature change in the light emission efficiency at Is in the temperature range of 50° C. to 90° C. is 5% or less, and more preferably 3% or less. Here, 5% or 3% is an absolute value.

Note that the LED 30 is often used at a high temperature and it is advantageous if the temperature coefficient of the light emission efficiency of the LED 30 is positive. In other words, whether the coefficient of the change in the light emission efficiency of the LED 30 is positive or negative has a great influence on the area control. However, the positive value is advantageous to increasing the brightness of the entire screen.

The light emission efficiency E can be expressed as E=φ/W, where φ is the light beam from the LED 30 and W is the input power. Further, W can be expressed as W=If×Vf, where If is the current of the LED 30 and Vf is the voltage between the terminals of the LED 30. The LED is current driven, so that If is a constant value. FIG. 16 is a graph showing the relationship of the current If of the LED 30, the inter-terminal voltage Vf, and the light beam from the LED 30, with respect to the temperature Ts when the temperature coefficient is positive. When the current If is constant, the temperature coefficient of the light beam is negative. However, the temperature coefficient of the light emission efficiency is positive, that is, the absolute value of the temperature coefficient of the inter-terminal voltage Vf of the LED 30 is greater than the absolute value of the temperature coefficient of the light beam.

### Second Embodiment

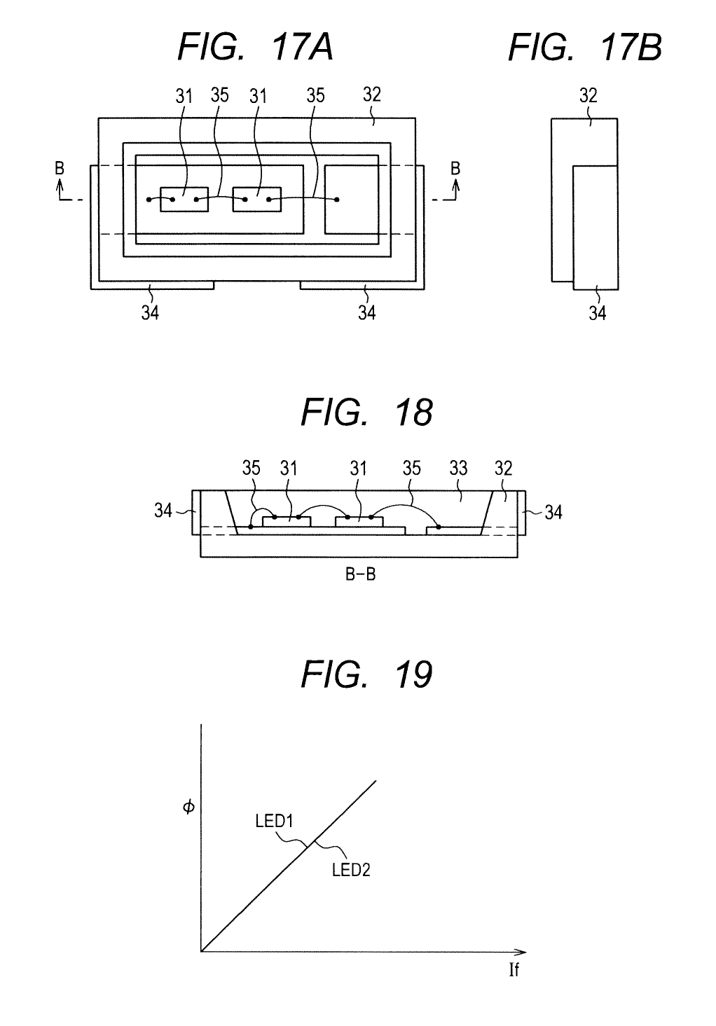

FIG. 17A is a front view of the LED 30 used in a second embodiment according to the present invention. FIG. 17B is a side view. In this embodiment, two LEDs 30 are connected in series. In FIG. 17A, two LED chips 31 are placed on one lead frame 34. The LEDs 30 are connected in series by the wires 35. The other configuration is the same as the configuration of the first embodiment shown in FIG. 12A. FIG. 17B is the side view of FIG. 17A. The configuration of FIG. 17B is the same as the first embodiment shown in FIG. 12B, and the description thereof will be omitted.

FIG. 18 is a cross-sectional view taken along line B-B of FIG. 17A. In FIG. 18, the two LED chips 31 are connected in series by the wire 35 on one lead frame 34. The other configuration is the same as the first embodiment in FIG. 13, and the description thereof will be omitted.

In this embodiment, the sign of the temperature coefficient of the light emission efficiency is different between the first LED chip 31 and the second LED chip 31. For example, the temperature coefficient of the light emission efficiency of the first LED chip 31 is positive, and the temperature coefficient of the second LED chip 31 is negative. Then, the temperature characteristics of the light emission efficiency are cancelled by the two LED chips 31. As a result, the temperature change in the light emission efficiency is close to zero in the LEDs 30 as a whole.

FIG. 19 is a graph showing the relationships between the current If and the light beam φ in the two LED chips 31 according to this embodiment. As shown in FIG. 19, it is desirable that the relationships between the current If and the light beam φ in the two LED chips 31 are the same. However, they are not necessarily the same, but are close to the extent that uneven brightness does not occur.

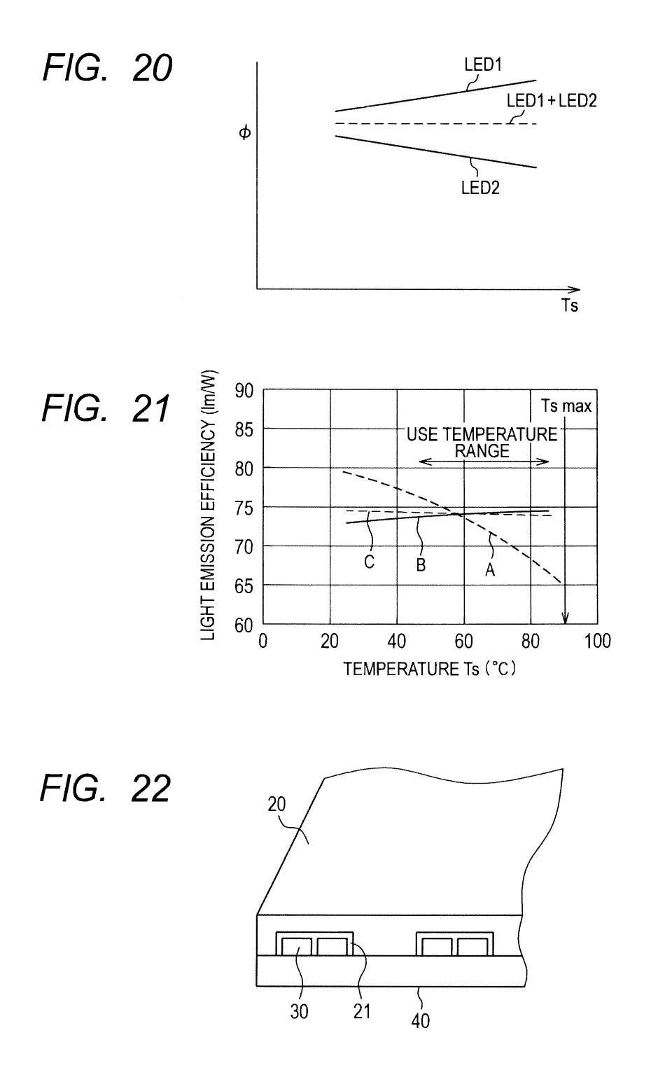

FIG. 20 is a graph showing the relationships between the temperature Ts and the light beam φ in the LED chips 31 according to this embodiment. In FIG. 20, an LED chip (LED 1) has the positive temperature characteristics of the light emission efficiency, so that the light beam φ increases as the temperature increases. On the other hand, an LED chip (LED 2) has the negative temperature characteristics of the light emission efficiency, so that the light beam φ decreases as the temperature increases. As a result, the total temperature change in the light emission efficiency of the two LED chips (LED 1 and LED 2) can be close to zero.

FIG. 21 is a graph showing the temperature dependencies of the light emission efficiency of the LEDs 30, with respect to the LED 30 used in the conventional example, the LED 30 used in the first embodiment, and the LED 30 used in the second embodiment. In FIG. 21, the horizontal axis represents Is and the vertical axis represents the light emission efficiency. In FIG. 21, the dashed line A shows a conventional example, the dashed line B shows an example of the first embodiment, and the dashed line C shows an example of the second embodiment. As can be seen from FIG. 21, the temperature dependency of the light emission efficiency in the second embodiment is more improved than that in the first embodiment.

In FIG. 21, the total temperature characteristics of the light emission efficiency of the two LEDs 30 are nearly zero, but not necessarily equal to zero. The temperature dependency of the light emission efficiency at Ts in the temperature range of 50° C. to 90° C. is 5% or less, and more preferably 3% or less. Note that 5% or less or 3% or less is an absolute value. In addition, as described in the first embodiment, when the total temperature characteristics of the light emission efficiency of the two LEDs 30 are a positive value of 5% or less and more preferably 3% or less, the LEDs 30 are used at a high temperature, so that it is advantageous to the brightness characteristics.

### Third Embodiment

FIG. 22 is a perspective view of a third embodiment showing the light guide plate, the wiring substrate 40, and the LEDs 30 inserted into the recesses 21 of the light guide plate. In FIG. 22, two LEDs 30 are placed into the recess 21 of the light guide plate. The two LEDs 30 are paired to illuminate a predetermined area. The signs of the temperature characteristics of the light emission efficiency of the two LEDs 30 are opposite to each other. For example, the temperature characteristics of the light emission efficiency of the first LED 30 is the same as the temperature characteristics of the LED (LED 1) shown in FIG. 20, and the temperature characteristics of the light emission efficiency of the second LED 30 is the same as the temperature characteristics of the LED (LED 2) shown in FIG. 20. By combining the LEDs 30 with the opposite signs of the temperature characteristics, it is possible to cancel the temperature characteristics of the light emission efficiency of the LEDs 30. As a result, the temperature change in the light emission efficiency can be close to zero.

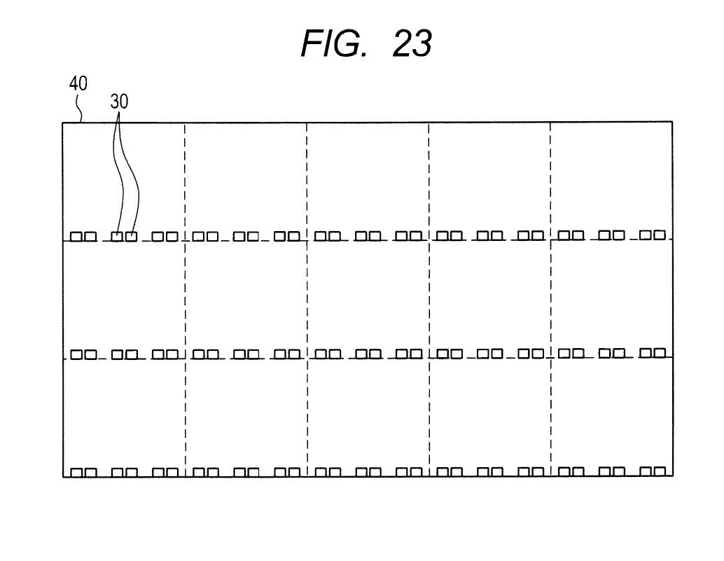

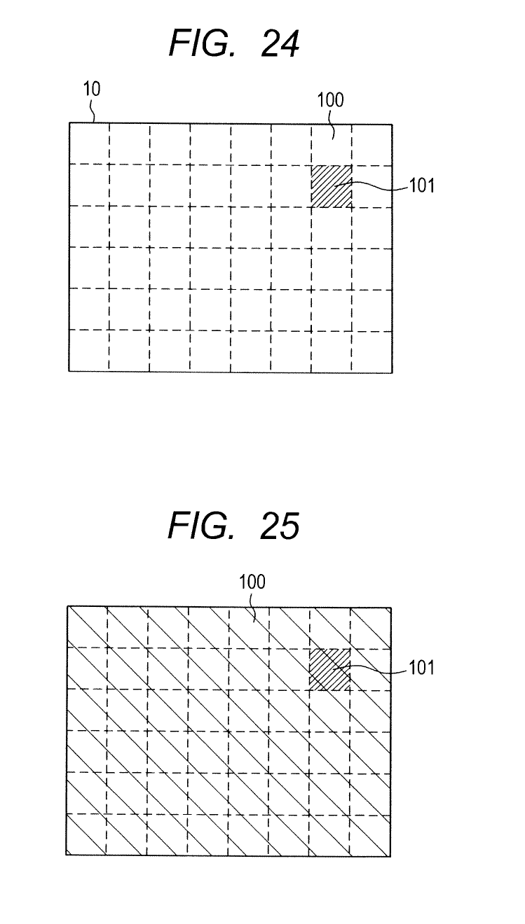

FIG. 23 is a plan view showing the state in which the pairs of LEDs 30 are provided on the wiring substrate 40. Each pair of LEDs 30 corresponds to each of the recesses 21 of the light guide plate. In FIGS. 22 and 23, the LEDs 30 are arranged in pairs of two. However, it is also possible to reduce the temperature characteristics of the light emission efficiency by arranging the LEDs 30 in groups of three or four or more. In this case, the length of the recess 21 is increased so that each group of LEDs 30 can be placed into the recess 21. When the LEDs 30 are arranged in groups of three, for example, one of the three LEDs 30 has a positive light emission efficiency, and the remaining two LEDs 30 have a negative coefficient of the light emission efficiency, which is half the value of the other LED 30. In this way, it is possible to reduce the amount of temperature change in the light emission efficiency as a whole.

In this embodiment, a plurality of the LEDs 30 are used to reduce the temperature characteristics of the light emission efficiency. Similar to the first or second embodiment, the temperature characteristics of the light emission efficiency in the temperature range of 50° C. to 90° C. are 5% or less and more preferably 3% or less in absolute value. When the temperature characteristics of the pair of LEDs 30 are positive, the LEDs 30 are used at a high temperature, which is advantageous to the brightness characteristics.

In this embodiment, a pair of LEDs with different characteristics is placed into one recess. However, LEDs with different characteristics can also be placed into different recesses in the same control area. Further, when the recess is formed as a continuous groove, LEDs with different characteristics can be placed into the groove in the same control area.

As described above, by using this embodiment, the occurrence of uneven brightness can be prevented even when area control is performed.

In the above embodiments, the recesses are provided in the light guide plate and the LEDs are placed into the recesses, which has been described as an example. However, the present invention is not limited to this configuration. For example, it goes without saving that the embodiments of the present invention can also be applied to the backlight in which LEDs are arranged on the side surface of the light guide plate as descried in JP-A No. 293339/2007. Further, although the above embodiments have been described using side-view LED as an example, top-view LED can also used as long as the change in the light emission efficiency with respect to the temperature change is small. Further, the embodiments of the present invention can also be applied to the so-called direct-type LED without using the light guide plate, in which top-view LEDs are arranged in a matrix on the back side of the liquid crystal display panel to perform area control by controlling each top-view LED or each group of a plurality of LEDs separately.

What is claimed is:

1. A backlight comprising an array of a plurality of light source blocks each having an LED, and a light guide member for converting light from the LED into a planar light to irradiate a liquid display panel,
wherein the backlight can control the intensity of the light for each light source block, and
wherein the temperature change in the light emission efficiency of the LED in the temperature range of 50° C. to 90° C. is 5% or less.

2. A backlight comprising a light guide member and an LED, in which area control can be performed,
wherein the light guide member has rows of recesses that are arranged at a predetermined pitch in a first direction,
wherein the rows of recesses are arranged at a predetermined interval in a second direction orthogonal to the first direction,
wherein the LED is a side-view LED and is placed into the recess, and
wherein the temperature change in the light emission efficiency of the LED in the temperature range of 50° C. to 90° C. is 5% or less.

3. The backlight according to claim 1, wherein the temperature change in the light emission efficiency of the LED in the temperature range of 50° C. to 90° C. is 3% or less.

4. The backlight according to claim 2, wherein the temperature change in the light emission efficiency of the LED in the temperature range of 50° C. to 90° C. is 3% or less.

5. The backlight according to claim 1
wherein the LED has two LED chips,
wherein the signs of the temperature coefficients of the light emission efficiency of the two LED chips are different from each other, and
wherein the temperature change in the light emission efficiency of the LED is the light emission efficiency of the LED using the two LED chips.

6. The backlight according to claim 2,
wherein the LED has two LED chips,
wherein the signs of the temperature coefficients of the light emission efficiency of the two LED chips are different from each other, and
wherein the temperature change in light emission efficiency of the LED is the light emission efficiency of the LED using the two LED chips.

7. A backlight comprising a light guide member and an LED, in which area control can be performed,
wherein the light guide member has rows of recesses that are arranged at a predetermined pitch in a first direction,
wherein the rows of recesses are arranged at a predetermined interval in a second direction orthogonal to the first direction,
wherein the LED is a side-view LED,
wherein a plurality of LEDs are placed into the recess,
wherein at least one of the plurality of LEDs has a different sign of the temperature coefficient of the light emission efficiency from the temperature coefficient signs of the other LEDs, and
wherein the temperature change in the light emission efficiency of the plurality of LEDs in the temperature range of 50° C. to 90° C. is 5% or less as a whole.

8. The backlight according to claim 7, wherein the temperature change in the light emission efficiency of the plurality of LEDs in the temperature range of 50° C. to 90° C. is 3% or less as a whole.

9. The backlight according to claim 7, wherein the number of LEDs is two.

10. The backlight according to claim 9, wherein the number of LEDs is two.

11. A liquid crystal display device comprising the backlight according the claim 1 on the back side of a liquid crystal display panel, in which area control can be performed.

12. A liquid crystal display device comprising the backlight according to claim 2 on the back side of a liquid crystal display panel, in which area control can be performed.

13. A liquid crystal display device comprising the backlight according to claim 3 on the back side of the liquid crystal display, in which area control can be performed.

14. A liquid crystal display device comprising the backlight according to claim 4 on the back side of the liquid crystal display panel, in which area control can be performed.

15. A liquid crystal display device comprising the backlight according to claim 5 on the back side of the liquid crystal display panel, in which area control can be performed.

16. A liquid crystal display device comprising the backlight according to claim 6 on the back side of the liquid crystal display panel, in which area control can be performed.
